(19) United States
(12) Patent Application Publication
(10) Pub. No.: US 2024/0238927 A1
(43) Pub. Date: Jul. 18, 2024

(54) MACHINE TOOL

(71) Applicant: FUJI CORPORATION, Chiryu (JP)

(72) Inventor: Masahiko MORI, Toyota-shi (JP)

(73) Assignee: FUJI CORPORATION, Chiryu (JP)

(21) Appl. No.: 18/403,821

(22) Filed: Jan. 4, 2024

(30) Foreign Application Priority Data
Jan. 16, 2023 (JP) 2023-004518

(51) Int. Cl. B23Q 3/157

(52) U.S. Cl. CPC B23Q 3/1572

(57) ABSTRACT

A machine tool includes a turret device, a turret slide device configured to slide the turret device along a turret slide axis, a tool spindle device, a tool spindle slide device configured to slide the tool spindle device along a tool spindle slide axis, a numerical control device configured to numerically control the turret slide device and the tool spindle slide device, and a programmable logic controller (PLC) connected to the numerical control device. When control of the turret slide axis for sliding the turret device and control of the tool spindle slide axis for sliding the tool spindle device are switched, the numerical control device shifts the control of the turret slide axis and the control of the tool spindle slide axis by changing a value of a predetermined device in the PLC.

### TECHNICAL FIELD

The present disclosure relates to a technique for switching an axis which is a control target in a machine tool.

### BACKGROUND ART

For example, Patent Literature 1 below describes a machine tool including a tool post commonly used in a machining area of each of two facing workpiece spindles. The machine tool of Patent Literature 1 controls the tool post by a machining program including a spindle selection M code, calls a correction arithmetic expression registered in advance for a changed machining area when the machining area is changed by the M code, and controls a position of the tool post by a command value corrected by the called correction arithmetic expression.

### PATENT LITERATURE

Patent Literature 1: JP-A-2009-172716

### BRIEF SUMMARY

### Technical Problem

A numerical control device used in a machine tool controls a device which is a control target by using, for example, an X axis, a Y axis, a Z axis, or a rotation axis about these axes. The numerical control device needs to change the axis which is the control target, for example, when the device which is the control target is switched from a turret device to a tool spindle device or from the turret device to another turret device. In this case, when the device before the change and the device after the change are controlled by different NC programs, it is necessary to transfer the control of the axis between the multiple NC programs. As a result, it is necessary to edit multiple NC programs, for example, when the transfer of the control of the axis is executed or when a transfer timing is desired to be changed, which may increase a work load.

The present disclosure has been made in view of the above problem, and an object of the present disclosure is to provide a machine tool capable of reducing a load of editing work of an NC program when it is desired to switch an axis which is a control target.

### Solution to Problem

In order to solve the above problem, according to an aspect of the present disclosure, there is provided a machine tool including: a turret device; a turret slide device configured to slide the turret device along a turret slide axis: a tool spindle device: a tool spindle slide device configured to slide the tool spindle device along a tool spindle slide axis: a numerical control device configured to numerically control the turret slide device and the tool spindle slide device; and a programmable logic controller (PLC) connected to the numerical control device, in which when control of the turret slide axis for sliding the turret device and control of the tool spindle slide axis for sliding the tool spindle device are switched, the numerical control device shifts the control of the turret slide axis and the control of the tool spindle slide axis by changing a value of a predetermined device in the PLC.

### Advantageous Effects

With the machine tool of the present disclosure, when the controls of the turret slide axis and the tool spindle slide axis are transferred between multiple NC programs executed by the numerical control device, an instruction can be sent via the PLC by changing a value of a device of the PLC. One of the NC programs can release or acquire the control of the axis by changing the value of the device and sending an instruction to another NC program. When it is desired to switch the axis which is the control target, a program for changing the value of the device of the PLC is added to one NC program, whereby the control of the axis can be transferred. As a result, a load of editing the NC program can be reduced.

### BRIEF DESCRIPTION OF DRAWINGS

FIG. 1 is a perspective view of a machine tool according to the present embodiment as viewed from a front surface.

FIG. 2 is a perspective view illustrating a main structure of a combined machining machine.

FIG. 3 is a right side view of FIG. 2.

FIG. 4 is a perspective view of a tool spindle device and a tool spindle slide device.

FIG. 5 is a block diagram of the machine tool.

FIG. 6 is a diagram illustrating a state in which control of an axis is transferred between a system 1 and a system 3.

FIG. 7 is a diagram for illustrating an identification number method of a comparative example.

FIG. 8 is a diagram for illustrating a switching method according to a signal command of the present embodiment.

FIG. 9 is a diagram illustrating axes assigned to axis sequential numbers when the controls of the axes are transferred between the systems.

### DESCRIPTION OF EMBODIMENTS

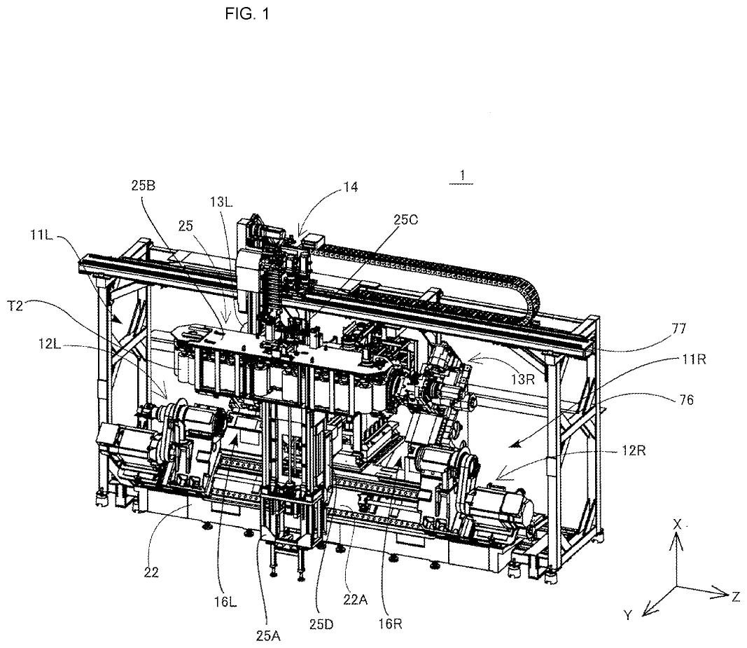

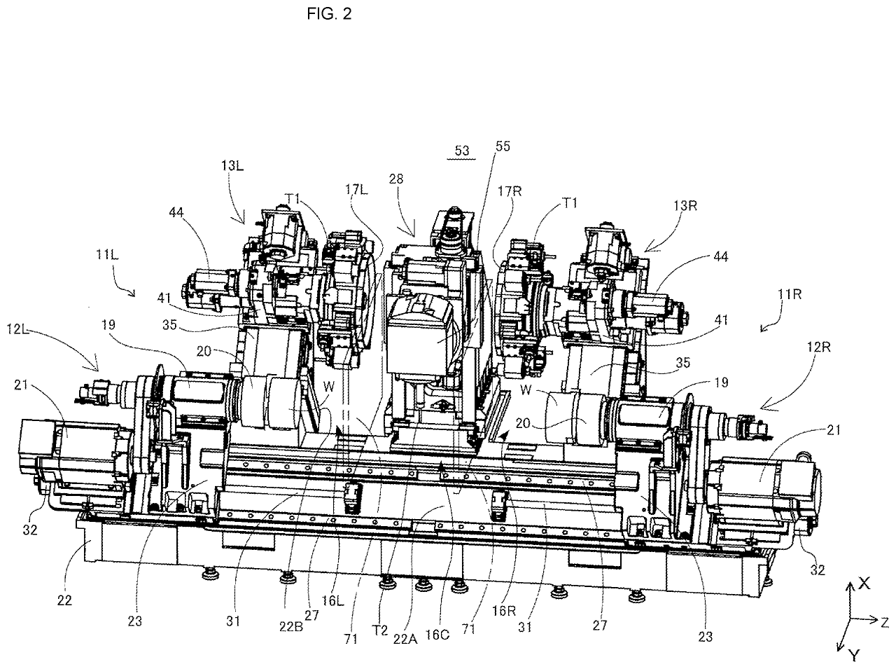

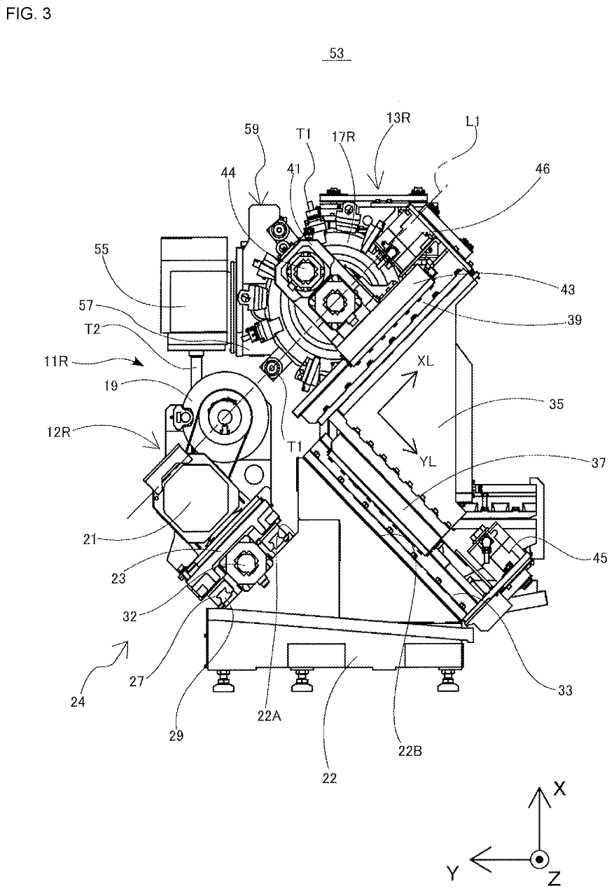

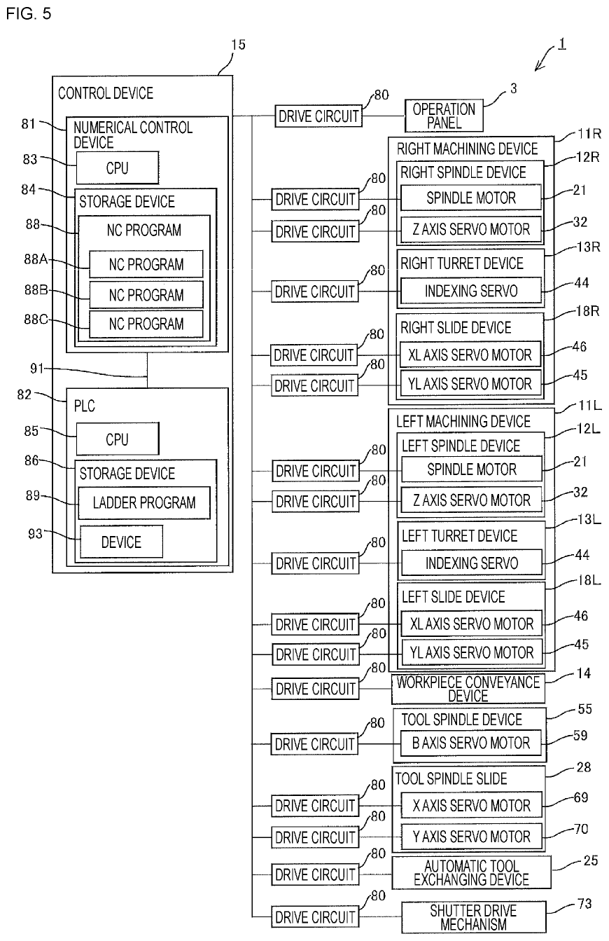

Hereinafter, an embodiment of a machine tool of the present disclosure will be described in detail with reference to the accompanying drawings. FIG. 1 is a perspective view of machine tool 1 of the present embodiment as viewed from a front surface. FIG. 2 is a perspective view illustrating a main structure of combined machining machine 53 provided in machine tool 1. FIG. 3 is a right side view of FIG. 2. In FIG. 1, a device cover covering machine tool 1, operation panel 3 (refer to FIG. 5), and the like are not illustrated. In the following description, as illustrated in FIGS. 1 to 3, the description will be made by referring, with a direction when machine tool 1 is viewed from the front surface as a reference, a right direction, which is a machine width direction and is a direction horizontal to an installation surface of the device, to as a Z axis direction, a front direction, which is parallel to the installation surface of the device and perpendicular to the Z axis direction, to as a Y axis direction, and an upper direction, which is perpendicular to the Z axis direction and the Y axis direction, to as an X axis direction. In the following description, character “L” is generally added to a sign related to the device disposed on a left side of machine tool 1, and character “R” is added to a sign related to the device disposed on a right side of machine tool 1.

### (Configuration of Machine Tool 1)

The front surface of machine tool 1 is covered with a device cover (not illustrated), and operation panel 3 (refer to FIG. 5) is attached to the front surface of machine tool 1. As illustrated in FIGS. 1 to 3, machine tool 1 includes left machining device 11L, right machining device 11R, workpiece conveyance device 14, and control device 15 (refer to FIG. 5) in addition to operation panel 3. Left machining device 11L and machining chamber 16L of left machining device 11L are provided on the left side of the device. Left machining device 11L is a turret-type lathe, and includes left spindle device 12L and left turret device 13L. In left spindle device 12L, a spindle is rotatably incorporated in cylindrical headstock 19, and chuck mechanism 20 for gripping workpiece W which is a machining target or releasing the gripping thereof is assembled. In FIG. 1, chuck mechanism 20 and workpiece W are not illustrated. As chuck mechanism 20, for example, multiple chuck claws that clamp workpiece W or a collet chuck can be adopted. A belt is wound around a spindle of headstock 19 via a rotation shaft of spindle motor 21 and a pulley. Left spindle device 12L rotates spindle motor 21 based on the control of control device 15, and rotates workpiece W in a C axis direction (rotation direction) about a direction (an example of the workpiece spindle of the present disclosure) parallel to the Z axis direction. Left turret device 13L has turret 17L to which multiple tools T1 (rotary tools or cutting tools) can be attached, and drives indexing servo motor 44 to rotate turret 17L to index tools T1. Left turret device 13L executes machining (cutting, drilling, or the like) on workpiece W gripped by left spindle device 12L by indexed tool T1.

Similarly, right machining device 11R and machining chamber 16R of right machining device 11R are provided on the right side of the device. Right machining device 11R has the same configuration as left machining device 11L, although orientations of right machining device 11R and left machining device 11L are symmetrical. Therefore, in the description of right machining device 11R, the same contents as those of left machining device 11L will be omitted. Right machining device 11R includes right spindle device 12R and right turret device 13R. The spindle of right spindle device 12R is parallel to the Z axis direction, and faces (opposes) the spindle of left spindle device 12L of left machining device 11L in a left-right direction. Therefore, left and right machining devices 11L and 11R are so-called facing biaxial-type lathes disposed symmetrically in the left-right direction. Right turret device 13R executes machining on workpiece W gripped by right spindle device 12R by tool T1 obtained by driving indexing servo motor 44 and rotating and indexing turret 17R. In addition, right machining device 11R need not have the same configuration as left machining device 11L. For example, at least one of left machining device 11L and right machining device 11R may be another type of machining device, such as a machining center.

Headstock 19 and spindle motor 21 of each of left and right spindle devices 12L and 12R are mounted on spindle slide 23. Bed 22 of machine tool 1 has a slant bed structure to reduce the dimension in a machine body front-rear direction. The surface of bed 22 on which left and right spindle devices 12L and 12R are mounted is a front inclined surface 22A that is lowered in front. Conversely, mounting surfaces of left and right turret devices 13L and 13R disposed on the machine body rear side are rear inclined surfaces 22B (refer to FIG. 3) which are lowered to the rear.

Each of left and right spindle devices 12L and 12R is provided with drive mechanism 24 (refer to FIG. 3) that moves spindle slide 23 in the Z axis direction along front inclined surface 22A of bed 22. Pair of drive mechanisms 24 includes pair of guide rails 27, pair of guide blocks 29 (refer to FIG. 3), ball screw mechanism 31, Z axis servo motor 32, or the like. Pair of guide blocks 29 is fixed to a lower surface of spindle slide 23. Pair of guide blocks 29 are slidably attached to pair of guide rails 27, respectively. Accordingly, spindle slide 23 is movable in the Z axis direction along pair of guide rails 27 provided on front inclined surface 22A of bed 22.

Left and right spindle devices 12L and 12R are movable in a direction parallel to the Z axis direction by respective ball screw mechanisms 31 of pair of drive mechanisms 24, and a screw shaft of ball screw mechanism 31 is disposed parallel to the Z axis direction and supported between pair of guide rails 27 via bearings. Z axis servo motor 32 of each of pair of drive mechanisms 24 is provided on the outer sides of left and right spindle devices 12L and 12R in the machine body width direction. The rotation shaft of Z axis servo motor 32 is coupled to the screw shaft of ball screw mechanism 31. Meanwhile, a nut member (not illustrated) through which a screw shaft passes is fixed to spindle slide 23. Pair of drive mechanisms 24 can linearly move (slide) spindle slide 23 to any position in the Z axis direction by driving the Z axis servo motors 32 to rotate the screw shafts based on the control of control device 15 (refer to FIG. 5).

Machine tool 1 includes left and right slide devices 18L and 18R (refer to FIG. 5) for moving turrets 17L and 17R of left and right turret devices 13L and 13R in a YL axis direction and an XL axis direction (refer to FIG. 3) at an angle of 45 degrees with respect to a horizontal direction and a vertical direction on an XY plane orthogonal to the Z axis direction in order to move tool T1 to a work position for machining workpiece W. Left slide device 18L is a device for sliding left turret device 13L. Right slide device 18R is a device for sliding right turret device 13R. As illustrated in FIG. 3, rear inclined surface 22B parallel to the YL axis is formed on bed 22, and YL axis guide rail 33 is fixed thereto. Each of left and right slide devices 18L and 18R includes substantially triangular base slide 35 above rear inclined surface 22B. Base slide 35 is provided with guide section 37 for sliding YL axis guide rail 33 on one side, mounting surface for mounting turrets 17L and 17R are formed on the sides adjacent to each other at 90 degrees, and XL axis guide rail 39 is provided with on the mounting surface. Each of the left and right slide devices 18L and 18R includes turret slide 41 on which left and right turret devices 13L and 13R (turrets 17L and 17R and indexing servo motor 44) are mounted. Guide section 43 of turret slide 41 is slidably engaged with the XL axis guide rail 39 and is movable along machining movement line LI parallel to the XL axis.

A ball screw mechanism is provided on base slide 35 and turret slide 41. A screw shaft parallel to the YL axis and the XL axis is supported by bearings on each of YL axis guide rail 33 and XL axis guide rail 39. Each screw shaft is inserted into a nut member fixed to base slide 35 or turret slide 41. Left and right slide devices 18L and 18R include YL axis servo motor 45 and XL axis servo motor 46 as drive sources for sliding left and right turret devices 13L and 13R. Each screw shaft is coupled to the rotation shaft of YL axis servo motor 45 or XL axis servo motor 46. Accordingly, left and right turret devices 13L and 13R can perform not only the movement control of turrets 17L and 17R in the respective directions of the YL axis and the XL axis, but also the movement control of turrets 17L and 17R in the horizontal direction in which the movements in both axial directions are combined, by the drive control of YL axis servo motor 45 and XL axis servo motor 46 of left and right slide devices 18L and 18R.

Machine tool 1 has both functions of an NC lathe and a machining center. Machine tool 1 includes tool spindle device 55 at the center of the machine body and behind automatic tool exchanging device 25. Machine tool 1 includes combined machining machine 53 including left and right machining devices 11L and 11R, and tool spindle device 55 on one bed 22. Tool spindle device 55 enables machining at a depth and an angle difficult for left and right turret devices 13L and 13R, for example. Machine tool 1 also includes tool spindle slide device 28 that slides tool spindle device 55.

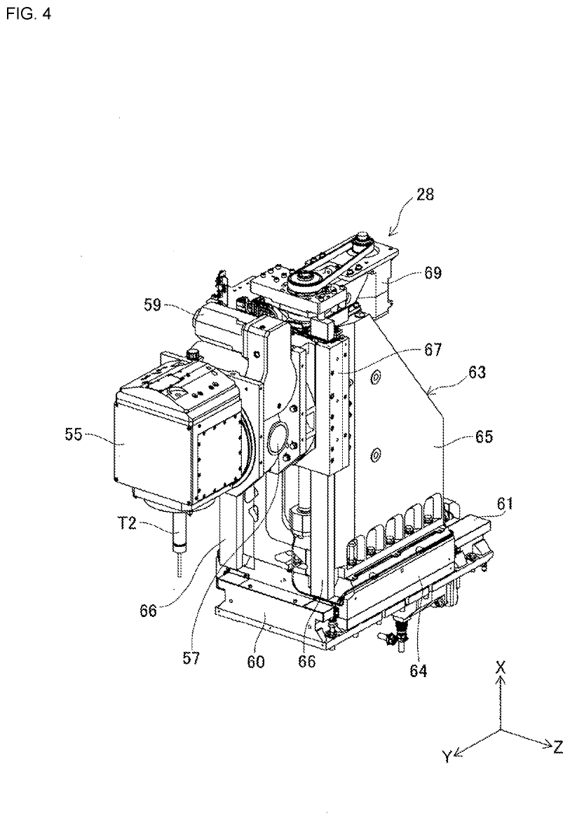

FIG. 4 is a perspective view of tool spindle device 55 and tool spindle slide device 28. As illustrated in FIGS. 2 to 4, tool spindle slide device 28 is a device that moves tool spindle device 55 (tool T2) in the X axis direction and the Y axis direction. Tool spindle device 55 can adjust the angle of tool T2 about a B axis which is a rotation axis parallel to the Y axis direction. In tool spindle device 55, a servo motor for a spindle or a tool spindle is incorporated, and various tools T2 housed in automatic tool exchanging device 25 (refer to FIG. 1) can be replaced with a tool mounting section provided at a lower end portion thereof. Tool spindle device 55 is rotatably attached to X axis slide 57 of tool spindle slide device 28, and is configured to receive rotation of B axis servo motor 59 via a rotation transmission mechanism.

Tool spindle slide device 28 has, on the upper surface of bed 22, guide rail 60 for moving main body portion 65 of tool spindle slide device 28 and tool spindle device 55 in the Y axis direction. Guide rail 60 includes pair of Y axis rails 61 (only Y axis rail 61 on the right side is illustrated in FIG. 4) along the Y axis direction. Pair of Y axis rails 61 are provided along a direction parallel to the Y axis direction in a state of being parallel to each other with a predetermined interval therebetween in the Z axis direction. Y axis slide 63 of tool spindle slide device 28 includes guide section 64, main body portion 65, and pair of X axis rails 66. In Y axis slide 63, guide section 64 provided at a lower portion of main body portion 65 is attached to each of pair of Y axis rails 61 and is attached to be slidable with respect to pair of Y axis rails 61. Accordingly, Y axis slide 63 is slidable in the Y axis direction.

Pair of X axis rails 66 is attached to the front surface of main body portion 65. Pair of X axis rails 66 is provided along a direction parallel to the X axis direction in a state of being parallel to each other with a predetermined interval therebetween in the Z axis direction. In X axis slide 57, guide section 67 provided on the rear side is attached to each of pair of X axis rails 66 and is attached to be slidable with respect to pair of X axis rails 66.

Y axis slide 63 is movable in the Y axis direction with respect to Y axis rail 61 by a ball screw mechanism (not illustrated) provided at a coupling portion between guide section 64 and Y axis rail 61. Similarly, X axis slide 57 is movable in the X axis direction with respect to X axis rail 66 by a ball screw mechanism (not illustrated) provided at a coupling portion between guide section 67 and X axis rail 66. In the ball screw mechanism, a screw shaft disposed in each axial direction is supported via a bearing, and the screw shaft passes through a nut member fixed to X axis slide 57 or Y axis slide 63. X axis servo motor 69 or Y axis servo motor 70 (refer to FIG. 5) of tool spindle slide device 28 is coupled to each screw shaft, and X axis slide 57 or Y axis slide 63 can be linearly moved by the rotation output of each servo motor. Accordingly, in tool spindle device 55, the position of tool T2 in the X axis direction and the Y axis direction is changed by drive control of X axis servo motor 69 and Y axis servo motor 70 of tool spindle slide device 28, and the attitude (angle) of tool T2 with respect to workpiece W can be adjusted by drive control of B axis servo motor 59.

In addition, combined machining machine 53 is capable of simultaneously machining workpiece W by left and right machining devices 11L and 11R, and is also capable of performing tool exchange in tool spindle device 55. Therefore, as illustrated in FIG. 2, two separation shutters 71 are provided so that each device is not affected by coolant, chips, or the like. Two separation shutters 71 are disposed on both sides of tool spindle device 55 in the left-right direction, and are configured to individually move horizontally in the machine body front-rear direction by shutter drive mechanism 73 (refer to FIG. 5) including a servo motor and the like. Combined machining machine 53 can be separated into machining chambers 16L and 16R and tool exchange chamber 16C by two separation shutters 71. Machining chamber 16L is a machining chamber that separates left spindle device 12L and left turret device 13L from other devices, and performs machining on workpiece W gripped by left spindle device 12L by left turret device 13L. Similarly, machining chamber 16R is a machining chamber in which right turret device 13R performs machining on workpiece W of right spindle device 12R. Tool exchange chamber 16C is a work chamber for separating tool spindle device 55 and exchanging tool T2 of tool spindle device 55. Control device 15 drives shutter drive mechanism 73 to move separation shutter 71 forward to partition each room, or to store separation shutter 71 rearward to open each room. In addition to the control of partitioning into three rooms, control device 15 can create a wide space in which machining chamber 16L and tool exchange chamber 16C are connected to each other, for example, by moving only one of two separation shutters 71 forward. At this time, as will be described later, control device 15 can perform machining on workpiece W gripped by left spindle device 12L by tool spindle device 55, and drive automatic tool exchanging device 25 to convey tool for exchanging T2 to the tool exchange position in advance. Further, as will be described later, the control of the axis can be shifted in accordance with the use of tool spindle device 55 in expanded machining chambers 16L and 16R.

Machine tool 1 includes automatic tool exchanging device 25 in front of machine tool 1. Tool spindle device 55 is provided at the center of machine tool 1 in the Z axis direction, and tool T2 (spindle head tool) can be replaced between tool spindle device 55 and automatic tool exchanging device 25. Tool T2 is, for example, a drill or an end mill. As illustrated in FIG. 1, automatic tool exchanging device 25 includes exchanging device main body 25A standing on an installation surface, tool magazine 25B provided on an upper portion of exchanging device main body 25A, shift device 25C that moves tool T2, and tool changer 25D that exchanges tool T2. Tool magazine 25B is disposed at a position above tool spindle device 55 and on the front side of machine tool 1, and accommodates tool for exchanging T2. In tool magazine 25B, tool T2 is attached to each of multiple tool holding members suspended from a roller chain, and the roller chain is rotated by driving of a servo motor, thereby moving any tool T2 to an indexing position provided at a central rear portion in the left-right direction. Tool T2 is detachably attached to a tool holder.

Shift device 25C includes a front-rear shifter that moves tool T2 in the front-rear direction and an up-down shifter that moves tool T2 in the up-down direction, and moves tool T2 between tool magazine 25B located at the upper portion of the machine body and the tool exchange position of tool spindle device 55 located at a lower position than tool magazine 25B. Shift device 25C is positioned at the indexing position of tool changer 25D by the front-rear shifter, carries tool T2 rearward, lowers carried tool T2 by the up-down shifter, and conveys tool T2 to the tool exchange position. Tool changer 25D replaces tool T2 in which shift device 25C is disposed at the tool exchange position with tool T2 attached to tool spindle device 55. Tool changer 25D is disposed near tool spindle device 55 in tool exchange chamber 16C, and includes, for example, a tool exchange arm having a pair of chucks for gripping tool T2, and a cam device for revolving the tool exchange arm. Tool changer 25D exchanges tool T2 held by the up-down shifter of shift device 25C and tool T2 of tool spindle device 55 by revolving the tool exchange arm.

Further, workpiece conveyance device 14 is, for example, a gantry type workpiece conveyance device, has traveling rail 77 and the like supported by frame structure 76, and moves a head (not illustrated) gripping workpiece W in each of the X, Y, and Z axial directions. Workpiece conveyance device 14 executes transfer of workpiece W between left and right machining devices 11L and 11R, an inlet device for carrying in workpiece W, an outlet device for discharging workpiece W, or the like, and the head. Further, left and right spindle devices 12L and 12R can slide in a direction parallel to the Z axis direction and move in a direction approaching each other, thereby directly transferring workpiece W.

Operation panel 3 illustrated in FIG. 5 includes, for example, a touch panel and a hard switch (such as a push button switch), and functions as a user interface. Operation panel 3 outputs a signal corresponding to an operation input of a user to the touch panel or the like to control device 15. Further, operation panel 3 changes the display content of the touch panel, changes the lighting state of the lamp, and the like based on the control of control device 15.

As illustrated in FIG. 5, machine tool 1 includes multiple drive circuits 80 in addition to control device 15 and the above-described devices (operation panel 3, right machining device 11R, workpiece conveyance device 14, and the like). Control device 15 includes numerical control device 81 and PLC 82. Numerical control device 81 includes CPU 83 and storage device 84. PLC 82 includes CPU 85 and storage device 86. Storage devices 84 and 86 include, for example, RAM, ROM, a flash memory, and the like. The configurations of storage devices 84 and 86 are not limited to the above-described configuration, and may be a configuration including an HDD and an SSD, a configuration including an external storage device such as a USB memory and a storage medium such as a DVD-RAM, or a combination thereof.

Storage device 84 stores NC program 88 for numerically controlling the operations of left and right machining devices 11L and 11R and the like in the machining of workpiece W. In addition to NC program 88, storage device 84 stores various data such as various setting data necessary for machining and a program for changing display contents of operation panel 3. Numerical control device 81 is electrically connected to the above-described devices via drive circuit 80, and can control the devices. For example, when drive circuit 80 is connected to operation panel 3, drive circuit 80 is an amplifier circuit that performs amplification, processing, and the like of a signal input from operation panel 3. For example, in the case of drive circuit 80 connected to a motor such as Z axis servo motor 32, drive circuit 80 is a driver circuit (servo amplifier) that changes a three-phase alternating current supplied to each servo motor based on an instruction signal (a movement amount, a position of a movement destination, a movement speed, a target torque, or the like) of control device 15. Numerical control device 81 executes NC program 88 by CPU 83, and outputs the instruction signal to drive circuit 80 (driver circuit) in accordance with a numerical command described in NC program 88 to perform control. Drive circuit 80 (driver circuit) executes feedback control for changing the three-phase alternating current based on, for example, encoder information of an encoder attached to each servo motor and an instruction signal of control device 15, and notifies numerical control device 81 of the completion of processing and the like. Thus, control device 15 slides right spindle device 12R and right turret device 13R along the respective axes to a desired position based on numerical control by numerical control device 81. The drive source for sliding each device is not limited to the servo motor, and other drive sources such as a stepping motor and a linear motor can be adopted.

PLC 82 is a Programmable Logic controller. Storage device 86 stores ladder program 89 for constructing a ladder circuit for processing various signals. PLC 82 executes ladder program 89 by CPU 85, and executes, for example, processing of outputting an output signal to elements such as various lamps, relays, and solenoids provided in machine tool 1 to drive the elements, and processing of inputting an input signal from elements such as a limit switch and a sensor by sequence processing based on ladder program 89. PLC 82 is connected to, for example, numerical control device 81 via communication bus 91 and can communicate with numerical control device 81. PLC 82 inputs and outputs signals to and from numerical control device 81 using device 93 constructed based on ladder program 89. Device 93 is, for example, a storage area constructed on storage device 86 by CPU 85 executing ladder program 89, and is a device for storing a value of a signal of an external I/O (a sensor or the like) provided in machine tool 1, a device for storing a value of a signal to be exchanged with numerical control device 81, a device for achieving a keep relay for storing a setting value, or the like. Accordingly, PLC 82 relays (inputs and outputs) signals between the external I/O provided in machine tool 1 and numerical control device 81.

For example, in the case of a PLC (PMC) manufactured by FANUC Corporation, device 93 of the device symbol “G” is used for an instruction from PLC 82 to numerical control device 81. Conversely, device 93 of the device symbol “F” is used for the instruction from numerical control device 81 to PLC 82. For example, when PLC 82 executes ladder program 89 and executes input/output (auxiliary function code signal or the like) based on a value stored in device 93 at a predetermined cycle (several ms or the like), numerical control device 81 reads a signal written to predetermined device 93 (hereinafter, may be referred to as a G device) of the device symbol “G”. Further, PLC 82 executes ladder program 89 and reads a signal written to predetermined device 93 (hereinafter, may be referred to as an F device) of a device symbol “F” by numerical control device 81 at a predetermined cycle. Accordingly, for example, a value of a signal input from numerical control device 81 (any NC program 88) to the F device is output to numerical control device 81 (another NC program 88) via the G device. As will be described later, control device 15 serves as a device of the present disclosure, for example, executes a command from any NC program 88 to another NC program 88 using device 93 with the device symbols “G” and “F”, and executes release and acquisition of control of the axis.

### (Transfer of Control of Axis)

Next, the transfer of the control of the axis will be described. Machine tool 1 of the present embodiment is a machining device for machining workpiece W, as described above, and includes three machining devices, that is, left turret device 13L, right turret device 13R, and tool spindle device 55 (hereinafter, may be referred to as respective machining devices). For example, as illustrated in FIG. 5, NC program 88 includes NC program 88A for left machining device 11L to execute machining, NC program 88B for right machining device 11R to execute machining, and NC program 88C for controlling tool spindle device 55, tool spindle slide device 28, and automatic tool exchanging device 25 to exchange tool T2. NC programs 88A to 88C may be separate data stored as separate files, data included in one file, or separate modules called from one program. In the following description, NC programs 88A to 88C (control systems controlled by the programs) that respectively control left machining device 11L, right machining device 11R, tool spindle device 55, and tool spindle slide device 28 (hereinafter, may be referred to as tool spindle device 55 or the like) will be described as “system 1, system 2, and system 3” in this order. In this case, system 1 is an NC program (control system) for left machining device 11L to machine workpiece W of left spindle device 12L by left turret device 13L. System 3 is a program for exchanging tool T2 and is a program for not executing machining. In the following description, NC programs 88A to 88C of systems 1, 2, and 3 are collectively referred to as NC program 88.

Each of systems 1 to 3 has a slide axis (turret slide, tool spindle slide) for sliding each machining device in the X axis direction and the Y axis direction. As described above, tool spindle device 55 and the like are used for machining in two machining chambers 16L and 16R, and exchange of tool T2 with automatic tool exchanging device 25 is performed. When it is desired to use tool spindle device 55 or the like for machining, systems 1 and 2 need to acquire control of tool spindle device 55 or the like from system 3. The configuration described above is an example, and for example, system 1 may have a slide axis for sliding each machining device in the Z axis direction.

Meanwhile, in NC program 88 of each system, for example, from the viewpoint of simplifying the control content, facilitating the editing, and the like, one axis is set as an axis of each control target in each axial direction. Accordingly, for example, NC program 88A of system 1 does not simultaneously control multiple X axes (different X axes) as the axes which are the control targets, but controls each of the X, Y, and Z axes and the rotation axes (C axis, B axis, and the like) about each axis as the axes which are control targets one by one. Therefore, when it is desired to use tool spindle device 55 for machining, systems 1 and 2 require processing of releasing the X axis and the Y axis of the own systems from the control and processing of acquiring the control of the X axis, the Y axis, and the B axis of tool spindle device 55 or the like from system 3. In accordance with this processing, acquired system 3 needs to release the X axis, the Y axis, and the B axis of tool spindle device 55 and the like. Then, systems 1 and 2 assign the acquired axis control as the axes of the control targets of the own systems. Note that the contents of the transfer of the control of the axis described above are examples. For example, when system 1 is configured to have the B axis (a rotation axis about an axis parallel to the Y axis direction), it is necessary to release and assign the B axis of system 1. In addition, NC program 88 of one system may control multiple axes (two different X axes or the like) simultaneously in each axial direction.

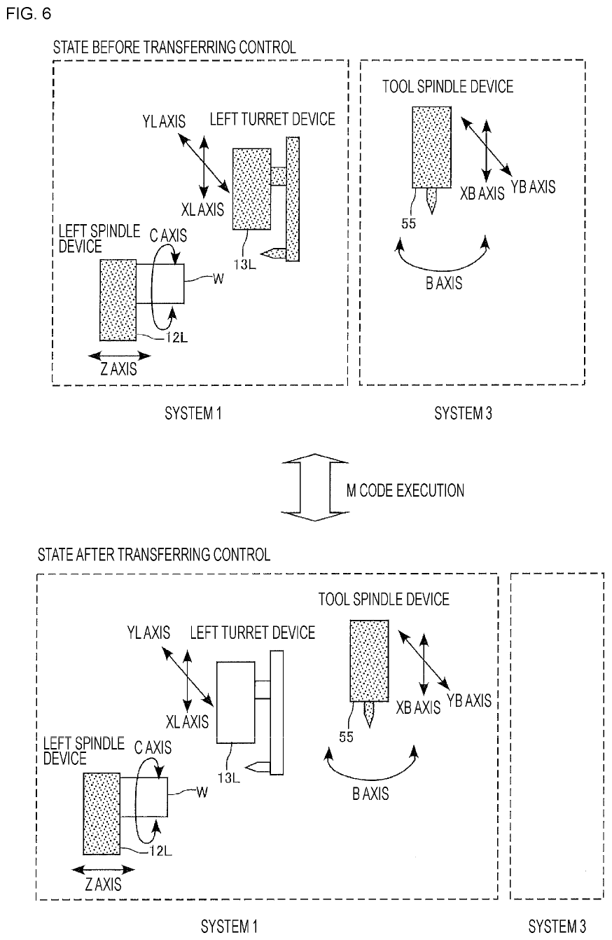

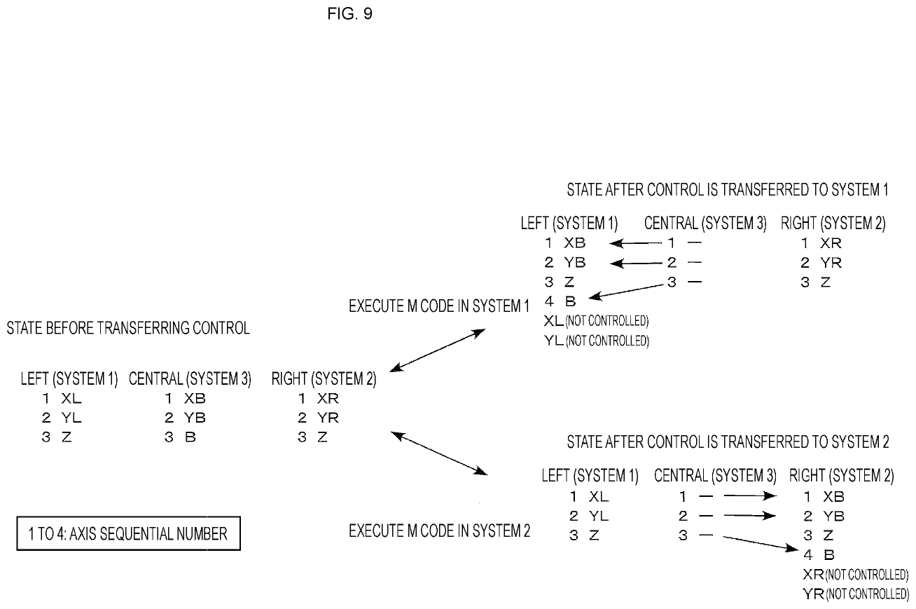

In the following description, a case will be described in which the control of the axis is transferred between system 1 and system 3. FIG. 6 illustrates a state in which the control of the axis is transferred between system 1 and system 3, and an upper drawing illustrates a state before the transfer, and a lower drawing illustrates a state after the transfer. Further, as illustrated in FIG. 6, for convenience of description, the sliding direction of left turret device 13L is referred to as an XL axis direction and a YL axis direction, a direction in which tool spindle device 55 is slid in a direction parallel to the X axis direction is referred to as an XB axis direction, and a direction in which tool spindle device 55 is slid in a direction parallel to the Y axis direction is referred to as a YB axis direction. In FIG. 9 to be described later, the sliding direction of right turret device 13R is referred to as an XR axis direction and a YR axis direction. In addition, in FIG. 6, except for workpiece W, hatched devices indicate devices that belong to the system surrounded by broken lines and are controlled, and white devices indicate devices whose control is released in the system surrounded by the broken lines.

The upper state of FIG. 6 is a state in which system 1 controls left turret device 13L, system 3 controls tool spindle device 55, and work is performed in each of machining chamber 16L and tool exchange chamber 16C. In the lower state of FIG. 6, the transfer of the control of the axis is completed, the XL axis and the YL axis of left turret device 13L are released, and the XB axis and the YB axis of tool spindle device 55 are under the control of system 1. When such control is acquired from system 3 to system 1, as described above, (1) release of the target axis of system 1, (2) release of the target axis of system 3, and (3) acquisition of the target axis from system 3 to system 1 are required.

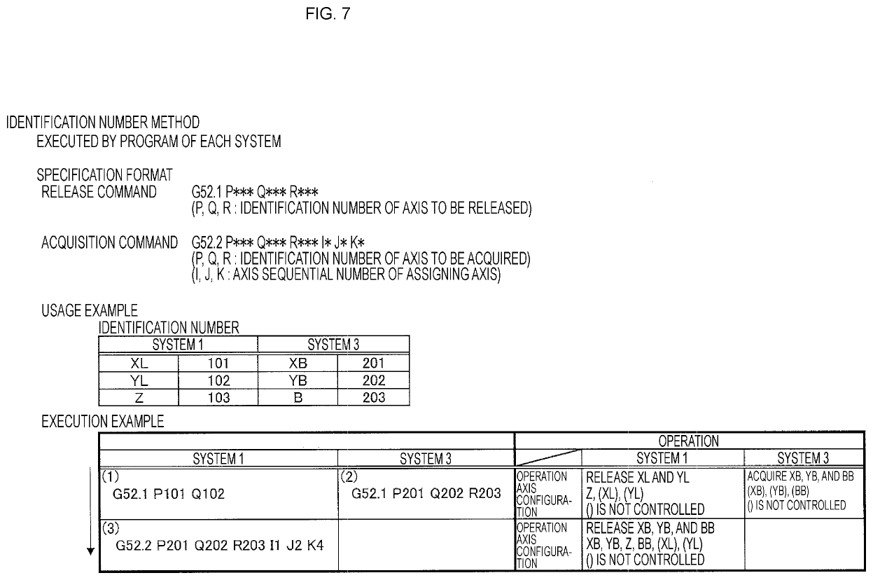

FIG. 7 illustrates an identification number method of a comparative example. In this identification number method, NC programs 88A and 88C of systems 1 and 3 execute release and acquisition of axes. As an example, a case where G code G52.1 indicating an axis release command and G code G52.2 indicating an axis acquisition command are used will be described. As illustrated in the usage example of FIG. 7, an identification number is set to the axis of each system. Specifically, identification numbers 101, 102, and 103 are set in this order for respective axes XL, YL, and Z, and identification numbers 201, 202, and 203 are set in this order for respective axes XB, YB, and B. As illustrated in the specification format, G52.1 describes the identification number (illustrated by P, Q, and R in FIG. 7) of the axis to be released after the code. As illustrated in the specification format, G52.2 describes an identification number (illustrated by P, Q, and R in FIG. 7) of an axis to be acquired after the code and an axis sequential number (illustrated by I, J, and K in FIG. 7) in which the axis is inserted after the code. The axis sequential number is, for example, an identification number assigned in order from 1 to the axis which is the control target.

FIG. 9 illustrates the axes assigned to the axis sequential numbers when the control of the axes is transferred between the systems. As illustrated on the left side of FIG. 9, in a state before the control of the axes is transferred, axes XL, YL, and Z are assigned to systems 1 and 2 in the order of axis sequential numbers 1, 2, and 3. In system 3, the XB, YB, and B axes are assigned in the order of axis sequential numbers 1,2, and 3.

In the execution example of FIG. 7, the contents of NC programs 88A and 88C of systems 1 and 2 are illustrated on the left side, and the operation when the contents are executed is illustrated on the right side. For example, in the transfer of the control of the axis from system 3 to system 1, (1) release of the target axis of system 1, (2) release of the target axis of system 3, and (3) acquisition of the target axis from system 3 to system 1 are executed. This execution example is an example. As illustrated in (1) of the execution example, NC program 88A of system 1 executes G52.1 to release designated parameters P101 and Q102, that is, the control of the XL and YL axes. Similarly, as illustrated in (2) of the execution example, NC program 88C of system 3 executes G52.1 to release the control of the designated XB, YB, and B axes. Thereafter, as illustrated in (3) of the execution example, NC program 88A of system 1 executes G52.2 to acquire designated parameters P201, Q202, and R203, that is, the control of the XB, YB, and B axes released in system 3. NC program 88A of system 1 assigns the acquired axes to designated parameters I1, J2, K4, that is, axis sequential numbers 1, 2, and 4.

Accordingly, the “state before transferring the control” illustrated on the left side of FIG. 9 transitions to the “state after transferring the control to system 1” illustrated on the upper right side. That is, the transfer of the control of the axis is completed. Each axis of the XB, YB, Z, and B axes is assigned to system 1 in the order of the axis sequential numbers 1 to 4. Axes XL and YL are not the control targets. As illustrated in the lower state of FIG. 6, numerical control device 81 executes NC program 88A of system 1, thereby operating tool spindle device 55 in the respective axial directions of XB, YB, and B and performing machining on workpiece W of left spindle device 12L. More specifically, for example, consider a case where numerical control device 81 executes NC program 88A of system 1, sets X0.0 as a parameter (coordinate value) in G code “G00” of the position determination instruction, and executes “G00. X0.0”. In this case, before the transfer, numerical control device 81 controls XL axis servo motor 46 via drive circuit 80 to slide left turret device 13L to a coordinate value of 0.0 (origin position) in the XL axis direction. After the transfer, numerical control device 81 controls X axis servo motor 69 via drive circuit 80 to slide tool spindle device 55 to a coordinate value of 0.0 (origin position) in the XB axis direction. In system 3, while tool spindle device 55 is used in system 1, tool magazine 25B and tool changer 25D can be controlled to carry the tool for exchanging T2 to the tool exchange position of tool spindle device 55 in advance.

However, in the identification number method of the comparative example illustrated in FIG. 7, it is necessary not only to add the codes of (1) and (3) to NC program 88A of system 1, but also to add the code of (2) to NC program 88C of system 3. That is, it is necessary to edit NC programs 88A and 88C of multiple systems. Similarly, even when the control of the axis is transferred through systems 2 and 3, it is necessary to edit NC programs 88B and 88C of multiple systems. Further, system 3 is NC program 88C for exchanging tool T2, and unlike NC programs 88A and 88B of systems 1 and 2 for performing machining, adjustment of the machining position or the like is not necessary. Therefore, when only NC programs 88A and 88B of systems 1 and 2 are changed without changing system 3 if possible, the number of programs which are the edit target or check target is reduced by one, and a work load on the user is significantly reduced.

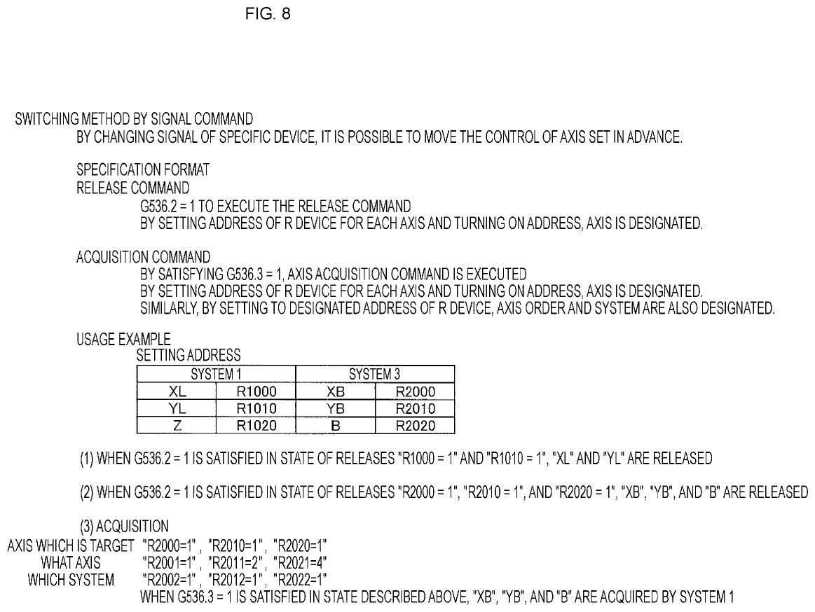

Here, system 1 of the present embodiment executes the transfer of the control of the axis using the switching method according to the signal command illustrated in FIG. 8. In this switching method, by changing (ON/OFF or the like) a signal of specific device 93 of PLC 82, it is possible to move the control of the axis set in advance. As illustrated in FIG. 8, for example, the value of the G device (G536.2) is set to 1 for specific device 93 to execute the axis release command. The axis which is the release target is designated using, for example, device 93 (hereinafter, may be referred to as an R device) of the internal relay of device symbol “R” as illustrated in the usage example of FIG. 8. In the XL, YL, and Z axes, addresses R1000, R1010, and R1020 of the R devices are set in advance in this order. In the XB, YB, and B axes, addresses R2000, R2010, and R2020 of the R devices are set in advance in this order.

In the case of releasing the control of the XL and YL axes of system 1, as illustrated in usage example (1) of FIG. 8, for example, the control of each of the XL and YL axes is released from system 1 by setting G536.2=1 of the G device in a state where “R 1000=1” and “R 1010=1” of the R device. In addition, as illustrated in (2), by setting G536.2=1 of the G device in a state where “R2000=1”, “R2010=1”, and “R2020=1” of the R device, the control of each of the XB, YB, and B axes is released.

In addition, for example, the acquisition command of the axis is executed by setting the value of the G device (G536.3) to 1 for specific device 93. The axis which is the acquisition target is designated using the R device as in the case of release. As illustrated in usage example (3) of FIG. 8, the G device (G536.3) designates the content of the acquisition processing of the axis as a set of the axis of the target, what axis in the axis sequential number, and information of the system. In usage example (3), each set is illustrated by being arranged vertically. For example, when acquiring “XB axis” by “designating system 1”, “to 1 of axis sequential number”, by setting G536.3=1 of the G device in a state where “R2000=1”, “R2001=1”, and “R2002=1” of the R device, the control of the XB axis can be acquired to 1 of the axis sequential number of system 1. Similarly, by setting three R devices of each combination and setting G536.3=1 of the G device, the control of the YB and B axes can be acquired.

In the identification number method of the comparative example, the release and acquisition of the axis are executed using the G code which is the preparation function. In contrast, in the switching method using the G device and the R device, release and acquisition of the axis can be collectively executed using the M code which is the auxiliary function. Specifically, for example, when a value is input to a specific F device (external input device of PLC 82) in ladder program 89, a program for setting the above-described G device and R device is created. NC program 88A of system 1 is associated with an instruction to change the values of the G device and the R device (G536.2=1) by designating (passing through) the F device in M230 (external M signal) of the M code. Thus, by executing M230 at a desired timing of NC program 88A of system 1, desired device 93 (G536.2=1, or the like) of PLC 82 can be set. PLC 82 writes a signal to the G device at a predetermined cycle to execute an output based on a value stored in advance to NC programs 88A and 88C of systems 1 and 3. In addition, NC programs 88A and 88C are set (programs or the like) to execute the release or acquisition of the axis, for example, based on reception of a specific input (an external input of the G device indicating a release command or an acquisition command of PLC 82 illustrated in FIG. 8). Thus, the release or acquisition of the axis can be executed via PLC 82. As a result, it is not necessary to add three G-codes as illustrated in the identification number method to NC programs 88A and 88C of systems 1 and 3 every time it is necessary to transfer the control of the axes. Preferably, the transfer of the axis can be executed only by adding the code of M230 to NC program 88A of system 1 at the timing when the transfer of the control of the axis is required.

In the switching method described above, both the release and acquisition of the axis are performed using PLC 82 (device 93). Accordingly, in system 1, the release and acquisition of the axis can be executed by executing one M code, and the number of lines (data amount) of NC program 88 can be reduced. However, the method is not limited thereto, and for example, only the release may be executed. As illustrated in FIG. 7, when the axis (such as the XB axis) on the side of system 3 that transfers the control of the axis can be released from the side of system 1, the axis can be transferred only by editing NC program 88A of system 1. Specifically, a G code for executing (1) release of the axis of system 1 and (3) acquisition of the axis of the switching method is added to NC program 88A of system 1. Moreover, (2) release of the axis of system 3 may be achieved by adding the M code to NC program 88A and using a G device (G536.2=1). That is, the switching method and the identification number method may be combined to execute the transfer of the control of the axis.

Although not particularly mentioned in the above description, device 93 used for the transfer of the control of the axis may be a bit device indicating a value of “1 or 0” or a word device indicating a numerical value. Accordingly, device 93 to be used is not limited to F, G, and R devices, and other devices 93 such as a K (keep relay) device and a D (data table) device may be used.

In addition, the code serving as a trigger for starting the transfer of the control of the axis in system 1 is not limited to the M code. For example, a method using a macro variable (also referred to as a macro function or a custom macro) may be used. Here, the macro variable is, for example, a function such as a variable, a calculation instruction, and a conditional branch used for transmitting a signal from numerical control device 81 (NC program 88) to PLC 82. For example, a macro variable for setting a value such as “1” to specific device 93 (G device or R device) may be defined in advance, and the macro variable may be called and executed from NC program 88A of system 1. Accordingly, the control of the axis can be transferred in the same manner as when the M code is executed.

Accordingly, NC program 88A of system 1 may be configured to set at least one of the M code and the macro variable, which are commands for numerical control. That is, in the transfer of the control of the axis, only the M code may be used, only the macro variable may be used, or both may be used. Then, numerical control device 81 executes NC program 88A of system 1, and changes the value of device 93 using at least one of the M code and the macro variable. A series of processing of not only releasing the axis of system 3 but also releasing the axis of system 1 and acquiring the axis can be defined by the M code or the macro variable. The transfer processing of the axis can be stylized by M codes or macro variables.

Further, in the above description, the transfer of the control of the axis from system 3 to system 1 has been described, but the control of the axis can also be transferred between other systems using device 93 in the same way. For example, in the transfer from system 3 to system 2, as illustrated in the lower right diagram of FIG. 9, slide axes XR and YR of right machining device 11R are released by the G device (G536.2=1) of the release command illustrated in FIG. 8. Further, similarly to the cases of system 3 and system 1, the XB, YB, and B axes of system 3 are released by the G device of the release command. Then, by the G device (G536.3=1) of the acquisition command illustrated in FIG. 8, the XB, YB, and B axes are assigned to the released axis sequential numbers 1 and 2 of system 2 and the vacant axis sequential number 4, respectively, so that tool spindle device 55 can be slid and machined in system 2. Such a series of control can be achieved by describing the M code and the macro variable in NC program 88B of system 2.

In addition, when the control of the XB axis or the like acquired from system 1 to system 3 or the control of the XB axis or the like acquired from system 2 to system 3 is returned, the transfer of the control can be executed using the M code or device 93. For example, similarly to usage example (2) illustrated in FIG. 8, system 1 releases the control of each of the XB, YB, and B axes from system 1 by using the G device (G536.2=1) of the release command and the R device for designating the XB, YB, and B axes for system 1. In addition, in PLC 82, for example, when a value of a predetermined F device is changed (written), setting (construction of a ladder circuit) is made so that a signal instructing assignment of the XB, YB, and B axes to system 3 is output from the G device. NC program 88C is set to acquire an axis (program or the like), for example, based on reading of an external input of the G device. Then, by executing the M code, system 1 releases the control of each of the XB, YB, and B axes and changes the value of the predetermined F device. Accordingly, according to an instruction from PLC 82 (based on an external input from the G device), system 3 assigns the control of the XB, YB, and B axes released from system 1 to the original axis sequential numbers, and executes return (reception) of the control of the axis. In addition, for example, in the execution of the M code, system 1 may execute not only the release of the XB, YB, and B axes and the assignment to system 3, but also the acquisition command of the switching method using device 93 for the control of the axis of the own device, assign the XL and YL axes to the axis sequential numbers 1 and 2 of the own device, and return the state of the control of the axis to the original state. Accordingly, systems 1 and 3 return to the upper state of FIG. 6. When the control of the axis is returned, the identification number method in FIG. 7 may be used, the switching method and the identification number method may be combined, or a macro variable may be used instead of the M code as a trigger. That is, the return method may be appropriately changed.

The method of returning the control of the axis is not limited to the above-described method of notifying from PLC 82. For example, NC program 88C of system 3 may monitor PLC 82. After releasing the XB, YB, and B axes, NC program 88C of system 3 monitors the value of specific device 93 (such as a G device or an R device). NC program 88C of system 3 does not acquire the control of the XB axis or the like while the value of device 93 is zero, and acquires the control of the axis when the value is changed to 1. NC program 88C of system 3 executes, for example, the M code in which the axis sequential numbers are set to 1, 2, and 3 for the XB, YB, and B axes, and G536.3=1 is set by designating system 3, similarly to usage example (3) of FIG. 8. Also in this method, the control of the XB, YB, and B axes can be returned from system 1 to system 3.

As described above, numerical control device 81 controls left slide device 18L by executing NC program 88A (an example of a turret NC program of the present disclosure) of system 1 that numerically controls left slide device 18L. In addition, numerical control device 81 controls tool spindle slide device 28 by executing an NC program 88C (an example of the tool spindle NC program of the present disclosure) of system 3 that numerically controls tool spindle slide device 28. Then, numerical control device 81 changes the value of device 93 (G device or the like) of PLC 82 according to a command of NC program 88A of system 1. PLC 82 outputs a signal based on the changed value of device 93 from PLC 82 to NC program 88C of system 3 by the processing of ladder program 89. Accordingly, among the XB, YB, and B axes controlled by system 3, the control of the axis necessary for system 1 is released. It is possible to release the control of the axis of system 3 by issuing a command from system 1 or system 2 to system 3. The release command of the axis can be transmitted by ladder processing. The axis to be released of system 3 may be at least one of the XB, YB, and B axes. System 3 may include an axis (such as a Z axis) other than the XB, YB, and B axis.

In addition, systems 1 and 2 can instruct to release the axes regardless of the operation state of system 3. Therefore, machine tool 1 preferably has a function of monitoring whether system 3 is using the XB, YB, and B axes. Specifically, for example, when at least one of the XB, YB, and B axes is used in the own system, NC program 88C of system 3 does not release the control of the axis until the use is completed even when the signal of the G device of the release command is input. When not all of the XB, YB, and B axes are used in the own system, NC program 88C releases the control of the axis based on the signal of the G device of the release command. In this case, NC program 88C of system 3 can monitor the usage states of the XB, YB, and B axes. Alternatively, PLC 82 may receive an input indicating whether the XB, YB, and B axes are being used from system 3 in predetermined device 93. For example, when the value of the predetermined F device is 1, it may be indicated that the device is in use, and when the value is 0, it may be indicated that the device is not in use. Then, PLC 82 may output a value of a G device or the like instructing release of the axis to NC program 88C only when a predetermined F device is zero (unused state).

As the turret slide axes (XL, YL, and Z axes) used in system 1, an axis sequential number (an example of turret slide axis identification information of the present disclosure) for identifying the turret slide axis is set in NC program 88A of system 1. In addition, as the tool spindle slide axes (XB, YB, and B axes) used in system 3, an axis sequential number (an example of tool spindle slide axis identification information of the present disclosure) for identifying the tool spindle slide axis is set in NC program 88C of system 3. When switching the control of the axes, numerical control device 81 releases the axes of the axis sequential numbers 1 and 2 (XL and YL) among the turret slide axes controlled in system 1. In addition, numerical control device 81 releases, from the control of system 3, the tool spindle slide axis of the axis sequential number of which the axial direction corresponds to (the directions of XL and XB and YL and YB correspond to each other) the axis sequential number of the axis whose control is released by system 1 among the tool spindle slide axes controlled by system 3. After releasing the control of the axes of systems 1 and 3, numerical control device 81 assigns the axis released from the control of system 3 as the axis which is the control target of NC program 88A of system 1 instead of the axis released from the control of system 1. Accordingly, the axis sequential numbers are associated with the axial directions in advance, so that the axis sequential numbers in which the axial directions correspond to each other can be shifted. The expression “the axial directions correspond to each other” is not limited to axes parallel to each other, and means that, when considering three axial directions such as XL and XB, and YL and YB, the same alphabetical characters are assigned as the characters for identifying the axes whose directions substantially correspond to each other.

When tool spindle device 55 machines workpiece W held by left spindle device 12L, numerical control device 81 changes the value of device 93 of PLC 82 to shift control of the XL and YL axes (an example of the first turret slide axis of the present disclosure) and control of the XB and YB axes of left slide device 18L. After the shifting, numerical control device 81 (NC program 88A of system 1) controls tool spindle slide device 28 based on the XB and YB axes to move tool spindle device 55 along the XB, YB, and B axes, and workpiece W held by left spindle device 12L is machined by tool spindle device 55. According to this, in combined machining machine 53 including the facing biaxial spindle devices (left and right machining devices 11L and 11R) and tool spindle device 55 at the center thereof, the axis is transferred between each of left and right machining devices 11L and 11R and tool spindle device 55, and tool spindle device 55 can be used in each spindle device. Since tool spindle device 55 can be used in common, the device can be downsized. Further, in combined machining machine 53, it is possible to release or acquire the axis from the spindle device side to tool spindle device 55.

Here, in the transfer of the axis using the above-described device 93, systems 1 and 2 can request system 3 to control the axis at a necessary timing in the own system. Therefore, in a state where system 1 acquires the control of the XB, YB, and B axes, system 2 may request system 3 to control the XB, YB, and B axes. In this case, when system 2 requests the control while system 1 is acquiring the control, for example, when the value of the G device (G536.2 or G536.3) is changed and executed, the axis of system 3 cannot be released or acquired. For example, in PLC 82, in ladder program 89 (ladder circuit) for setting a value written to the F device from system 1 or system 2 via the M code to the G device for outputting to system 3, a program for determining whether system 3 releases the axis is set. When the control of the XB, YB, and B axes of system 3 is requested from system 2 in a state where system 1 acquires the control of the XB, YB, and B axes, PLC 82 determines that the axis of system 3 is released by the program, and does not respond to the request of system 2. PLC 82 temporarily waits, for example, the request processing of system 2 until the control of the XB, YB, and B axes is released from system 1. As a result, system 2 enters a state of waiting for the processing of acquiring the control of the axis. When systems 1 and 2 are not used by each other and system 3 is not used, the control of the axis of system 3 can be acquired. For example, systems 1 and 2 repeat release and acquisition processing at predetermined time intervals using loop processing, thereby temporarily waiting until the above-described condition is satisfied, and after the condition is satisfied, acquire the control of the axis to start the machining by tool spindle device 55. When the control of the XB, YB, and B axes is requested from system 2 in a state where system 1 acquires the control of the XB, YB, and B axes, PLC 82 may respond to system 2 with an error.

Accordingly, NC programs 88 of systems 1, 2, and 3 of the present embodiment control left slide device 18L, right slide device 18R, and tool spindle slide device 28, respectively. For example, when system 1 is using XB, YB, and B axes, system 2 waits for processing by NC program 88B until system 1 releases (returns to system 3) XB, YB, and B axes. Accordingly, when the acquisition of the control of the axis in systems 1 and 2 is duplicated, a first one of the systems is temporarily made to wait, and after a second one of the systems is released, the acquisition or machining of the axis of the system which is made to wait can be started.

In the above embodiment, left and right spindle devices 12L and 12R are examples of a first workpiece spindle device and a second workpiece spindle device. Left and right turret devices 13L and 13R are examples of a turret device, a first turret device, and a second turret device. The respective slide axes of XL, YL, XR, and YR are examples of a turret slide axis, a first turret slide axis, and a second turret slide axis. The respective slide axes of XB and YB are examples of a tool spindle slide axis. The left and right slide devices 18L and 18R are examples of a turret slide device, a first turret slide device, and a second turret slide device. NC programs 88A and 88B of system 1 and system 2 are examples of a turret NC program, a first turret NC program, and a second turret NC program. NC program 88C of system 3 is an example of a tool spindle NC program.

As described above, according to the present embodiment described above, the following advantageous effects can be achieved.

When switching between control of turret slide axes (XL and YL axes or XR and YR axes) for sliding left and right turret devices 13L and 13R and control of tool spindle slide axes (XB and YB axes) for sliding tool spindle device 55, numerical control device 81 according to an aspect of the present embodiment shifts control of the slide axes by changing a value of predetermined device 93 (G device or the like) in PLC 82. According to this, when the control of the axis is transferred between the systems, an instruction can be sent via PLC 82 by changing the value of the G device or the like of PLC 82. When it is desired to switch the axis which is the control target, for example, the control of the axis can be transferred only by adding a program (M code, macro variable, or the like) for changing the value of device 93 of PLC 82 to NC program 88A of system 1. As a result, it is possible to transfer the control of the axis only by editing NC program 88A of system 1 without editing NC program 88C of system 3, and it is possible to reduce the load of the editing work of NC program 88. The user does not need to edit NC program 88C of tool spindle device 55, and can acquire the axis from system 3 to system 1 or system 2 by editing only systems 1 and 2.

The present disclosure is not limited to the above-described embodiment, and it is needless to say that various improvements and changes can be made without departing from the gist of the present disclosure.

For example, the configuration of machine tool 1 of the above embodiment is an example. Machine tool 1 may include only one of left machining device 11L and right machining device 11R. Left and right machining devices 11L and 11R are not limited to the facing biaxial-type lathes, but may be parallel biaxial-type lathes. Left and right machining devices 11L and 11R may have various configurations such as a horizontal lathe, a face lathe, a vertical lathe, a machining center, a milling machine, and a drilling machine.
The target axis to which the control of the present disclosure is transferred is not limited to the slide axis such as XL, YL, XB, or YB, and may be a rotation axis such as B or C.

### REFERENCE SIGNS LIST

1: machine tool, 12L, 12R: left and right spindle devices (first workpiece spindle device, second workpiece spindle device), 13L, 13R: left and right turret devices (turret device, first turret device, second turret device), 18L, 18R: left and right slide devices (turret slide device, first turret slide device, second turret slide device), 28: tool spindle slide device, 55: tool spindle device, 81: numerical control device, 82: PLC, 88A, 88B: NC program (turret NC program, first turret NC program, second turret NC program), 88C: NC program (tool spindle NC program), 89: ladder program, W: workpiece

1. A machine tool comprising:
a turret device;
a turret slide device configured to slide the turret device along a turret slide axis;
a tool spindle device;
a tool spindle slide device configured to slide the tool spindle device along a tool spindle slide axis;
a numerical control device configured to numerically control the turret slide device and the tool spindle slide device; and
a programmable logic controller (PLC) connected to the numerical control device,
wherein when control of the turret slide axis for sliding the turret device and control of the tool spindle slide axis for sliding the tool spindle device are switched, the numerical control device shifts the control of the turret slide axis and the control of the tool spindle slide axis by changing a value of a predetermined device in the PLC.

2. The machine tool according to claim 1,
wherein by executing a turret NC program for numerically controlling the turret slide device to control the turret slide device, executing a tool spindle NC program for numerically controlling the tool spindle slide device to control the tool spindle slide device, changing a value of the device of the PLC by a command of the turret NC program, and outputting a signal based on the changed value of the device from the PLC to the tool spindle NC program by processing of a ladder program of the PLC, the numerical control device releases control of the tool spindle slide axis necessary for the turret NC program among the tool spindle slide axes controlled by the tool spindle NC program.

3. The machine tool according to claim 2,
wherein at least one of an M code which is a command for numerical control and a macro variable is set in the turret NC program, and
the numerical control device executes the turret NC program and changes the value of the device by using at least one of the M code and the macro variable.

4. The machine tool according to claim 1,
wherein the numerical control device controls the turret slide device by executing a turret NC program for numerically controlling the turret slide device and controls the tool spindle slide device by executing a tool spindle NC program for numerically controlling the tool spindle slide device,
turret slide axis identification information for identifying the turret slide axis in the turret NC program is set in the turret slide axis,
tool spindle slide axis identification information for identifying the tool spindle slide axis in the tool spindle NC program is set in the tool spindle slide axis,
when the control of the turret slide axis of the turret slide device and the control of the tool spindle slide axis of the tool spindle slide device are switched, the numerical control device releases the turret slide axis of predetermined turret slide axis identification information among the turret slide axes controlled by the turret NC program from the control of the turret NC program,
the numerical control device releases, from the control of the tool spindle NC program, the tool spindle slide axis of the tool spindle slide axis identification information whose axial direction corresponds to the turret slide axis identification information of the turret slide axis whose control is released by the turret NC program among the tool spindle slide axes controlled by the tool spindle NC program, and
after the controls of the turret slide axis and the tool spindle slide axis are released, the numerical control device assigns the tool spindle slide axis released from the control of the tool spindle NC program as an axis which is a control target of the turret NC program instead of the turret slide axis released from the control of the turret NC program.

5. The machine tool according to claim 1, further comprising:
a first workpiece spindle device configured to rotate a workpiece about a workpiece spindle; and
a second workpiece spindle device disposed at a position facing the first workpiece spindle device in a direction parallel to the workpiece spindle,
wherein the tool spindle device is disposed between the first workpiece spindle device and the second workpiece spindle device in the direction parallel to the workpiece spindle,
the turret device includes a first turret device configured to machine the workpiece held by the first workpiece spindle device and a second turret device configured to machine the workpiece held by the second workpiece spindle device,
the turret slide device includes a first turret slide device configured to move the first turret device along a first turret slide axis and a second turret slide device configured to move the second turret device along a second turret slide axis, and
when the workpiece held by the first workpiece spindle device is machined by the tool spindle device, the numerical control device changes a value of the device of the PLC, switches control of the first turret slide axis and control of the tool spindle slide axis of the first turret slide device, then controls the tool spindle slide device based on the tool spindle slide axis to move the tool spindle device along the tool spindle slide axis, and machines the workpiece held by the first workpiece spindle device by the tool spindle device.

6. The machine tool according to claim 5,
wherein the numerical control device executes a first turret NC program for numerically controlling the first turret slide device to control the first turret slide device, executes a second turret NC program for numerically controlling the second turret slide device to control the second turret slide device, and executes a tool spindle NC program for numerically controlling the tool spindle slide device to control the tool spindle slide device,
the numerical control device changes a value of the device of the PLC by a command of the first turret NC program and outputs a signal based on the changed value of the device from the PLC to the tool spindle NC program by processing of a ladder program of the PLC to release control of the tool spindle slide axis necessary for the first turret NC program among the tool spindle slide axes controlled by the tool spindle NC program, and
when the second turret NC program is using the tool spindle slide axis necessary for the first turret NC program, the numerical control device causes processing by the first turret NC program to wait until the second turret NC program releases the tool spindle slide axis necessary for the first turret NC program.
